(19) United States
(12) Patent Application Publication
(10) Pub. No.: US 2020/0292994 A1
(43) Pub. Date: Sep. 17, 2020

(54) TIMEPIECE COMPRISING A DIAL ATTACHMENT DEVICE

(71) Applicant: ETA SA Manufacture Horlogere Suisse, Grenchen (CH)

(72) Inventor: Raphael BALMER, Vicques (CH)

(73) Assignee: ETA SA Manufacture Horlogere Suisse, Grenchen (CH)

(21) Appl. No.: 16/767,848

(22) PCT Filed: Dec. 10, 2018
(86) PCT No.: PCT/EP2018/084210

§ 371 Date: May 28, 2020

(30) Foreign Application Priority Data
Dec. 21, 2017 (EP) 17209869.1

(51) Int. Cl. G04B 19/14

(52) U.S. Cl. CPC G04B 19/14

(57) ABSTRACT

A timepiece includes a drive module, a dial including a central opening, an hour pipe passing through the central opening of the dial and driven in rotation by the drive module, and a dial attachment device. The attachment device includes a holding tube arranged around the hour pipe and mechanically connected to the drive module. The holding comes to bear against the dial or against a dial support to which the dial is attached.

### TECHNICAL FIELD

The present invention relates to the field of horology and more particularly to a timepiece comprising a device for attaching a dial of the conventional type or of the type comprising a solar cell.

### TECHNOLOGICAL BACKGROUND

Conventionally, a dial of a timepiece comprises, on the lower face side, i.e. on the movement side, metal feet arranged so as to be partly driven into holes machined in the plate of the movement. These metal feet are in particular used to hold the dial in place relative to the movement of the watch during the assembly thereof. The attachment of the dial in the movement plate according to the aforementioned method has the drawback of involving relatively complex machining operations, whereby the dial must be perforated several times with precision before assembling the metal feet. Moreover, in the event of significant impacts, there is still a risk of the feet of the dial breaking. Furthermore, the use of such dials in skeleton-type watches is not very aesthetically pleasing.

### SUMMARY OF THE INVENTION

The purpose of the present invention is thus to overcome the different aforementioned drawbacks. More specifically, one purpose of the invention is to propose a timepiece comprising a dial attachment device which is simple to implement and which ensures that the dial is firmly held in place while guaranteeing mechanical strength, in particular in the event of impacts along the axis of the hands.

For this purpose, the invention proposes a timepiece comprising a drive module, a dial comprising a central opening, an hour pipe passing through the central opening of the dial and driven in rotation by the drive module, and a device for attaching the dial. The attachment device comprises:
a holding tube arranged around the hour pipe and mechanically connected to/integral with the drive module, and
a retaining member arranged between the holding tube and the dial and/or a dial support to which the dial is attached.

According to one embodiment, the retaining member is arranged/disposed/situated between the holding tube and the dial and/or a dial support while bearing against a part of the dial that is adjacent to the central opening of the dial and/or against the dial support. Preferably, the retaining member is configured such that it bears against or such that it exerts a distributed axial stress on either an annular area of the dial which is adjacent and concentric to the central opening of the dial, or an annular area of the dial support.

According to one embodiment, the part of the dial adjacent to the central opening of the dial defines an annular area that is preferably set back relative to the surface of the dial, such that a surface of the top part of the holding tube is level with the dial.

According to one embodiment, the holding tube comprises a first cylindrical part having a first diameter and a second cylindrical part having a second diameter that is less than the first diameter. The retaining member is a washer arranged on the circumference of the second cylindrical part and bearing against the annular area of the dial or against the dial support so as to exert an axial force on the dial or the dial support.

According to one embodiment, the retaining member is a resilient ring, preferably of the circlip type, arranged inside a groove made on at least one part of the outer circumference of the holding tube such that the resilient ring bears against the annular area of the dial or against the dial support.

According to one embodiment, the holding tube comprises, on the one hand, a first tube mechanically connected to the drive module and comprising a threaded part on the inner circumference thereof, and on the other hand, a second tube in the form of a screw screwed into the threaded part of the first tube. The screw comprises a radial extension in order to form a circular bearing surface. The retaining member is in the form of a gasket, preferably of the O-ring type, arranged against the circular bearing surface of the screw and the annular area of the dial or the dial support so as to exert an axial force on the dial or the dial support.

According to one embodiment, the screw is embedded in the central opening of the dial.

According to one embodiment, the screw comprises a part which is raised relative to the dial and which extends radially in order to cover the central opening of the dial.

According to one embodiment, the timepiece further comprises a movement support and a circuit support arranged between the dial support and the drive module. The stack of each support forms a rigid base preventing the dial from becoming deformed in the event of an axial impact.

According to one embodiment, each support comprises a central opening in order to form a recess inside which the holding tube is at least partially adjusted.

According to one embodiment, the dial comprises or is formed by at least one solar cell.

### BRIEF DESCRIPTION OF THE FIGURES

Other features and advantages of the present invention will appear after reading the plurality of embodiments, which are provided for purposes of illustration only and not intended to limit the scope of the invention, given with reference to the accompanying drawings, wherein:

FIG. 1 shows a partial sectional view of the timepiece showing the dial attachment device according to a first embodiment of the invention;

FIG. 2 shows a partial sectional view of the timepiece showing the dial attachment device according to a second embodiment of the invention;

FIG. 3 shows a partial sectional view of the timepiece showing the dial attachment device according to a third embodiment of the invention; and

FIG. 4 shows a partial sectional view of the timepiece showing the dial attachment device according to a fourth embodiment of the invention.

### DETAILED DESCRIPTION OF THE INVENTION

As a whole, the device for attaching a dial according to the invention described hereinbelow, according to different embodiments, can be implemented in mechanical or quartz watches comprising a dial of the conventional/classic type, i.e. a dial comprising, for example, indexes distributed at regular intervals around the periphery of the dial, numbers representing the hours, for example in the form of appliques attached to the dial and, depending on the calibre, one or more apertures indicating, for example, the date or other information. The dial attachment device according to the invention can also be implemented in watches comprising a dial of the non-conventional type. The attachment device according to the invention is, for example, particularly well suited for attaching a dial comprising or formed by a solar cell for powering, for example, a battery and/or an electronic module of a so-called smart watch.

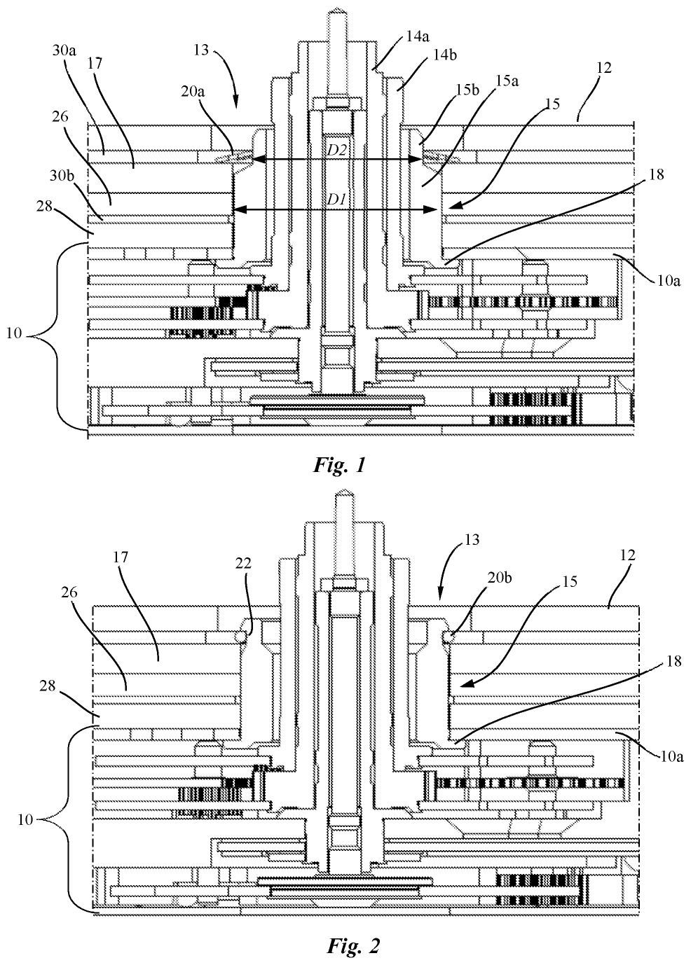

In the different embodiments shown in FIGS. 1 to 4, the device for attaching the dial 12 comprises a holding tube 15 arranged about the hour pipe 14b and is mechanically connected to the drive module 10, for example by hooking, by way of a radial extension 18. Moreover, this attachment device further comprises a retaining member 20a to 20c. This retaining member 20a to 20c is preferably a part fixed thereto. Such a retaining member 20a to 20c is a part that is preferably flexible and/or deformable, intended to be arranged between a second cylindrical part 15b of a holding tube 15 and the dial 12 or the dial support 17 of the watch. More specifically, under the effect of this second cylindrical part 15b, this retaining member 20a to 20c is capable of bearing against a part of the dial that is adjacent to a central opening 13 of this dial 12 and/or against the dial support 17.

With reference to FIG. 1, which shows a first embodiment of the invention, the timepiece comprises in particular a drive module 10, the dial 12 provided with a central opening 13, a cannon-pinion 14a and an hour pipe 14b passing through the central opening 13 of the dial 12 and driven in rotation by the drive module 10. The dial 12 is attached to a dial support 17, for example by means of a double-sided adhesive 30a. The shape of the dial support 17 is substantially identical to the shape of the dial 12. The dial support 17 is mounted on a movement support 26, which is attached to a circuit support, preferably a printed circuit support 28, for example by means of a double-sided adhesive 30b. The stack of the different supports 17, 26, 28 forms a rigid base on which the dial 12 rests, which has the benefit of preventing the dial 12 from becoming deformed in the event of an axial impact.

This rigid base is particularly well suited to a dial 12 in particular formed by a solar cell so as to prevent the glass substrate of the cell from potentially breaking in the event of a significant axial impact.

The timepiece comprises the device for attaching the dial 12 comprising the retaining member 20a, the holding tube 15 arranged about the hour pipe 14b and mechanically connected to the drive module 10. The holding tube 15 comprises a first cylindrical part 15a having a first diameter D1 and a second cylindrical part 15b having a second diameter D2 that is less than the first diameter D1. The first cylindrical part 15a is housed inside a tubular portion formed by the stack of the central openings of the dial support 17, of the movement support 26 and of the printed circuit support 28. This retaining member 20a comprises a retaining washer 20a and is arranged on the circumference of the second cylindrical part 15b. This retaining washer 20a extends radially such that the periphery thereof bears against the dial support 17 in order to exert an axial force on the dial support 17. One end of the first cylindrical part 15a comprises the radial extension 18, which is, for example, annular in shape, and which is mechanically connected or attached to a bridge 10a of the drive module 10.

With reference to FIG. 2, which shows a second embodiment of the invention, the retaining member 20b comprises a resilient ring 20b. This resilient ring 20b is arranged inside a groove 22 made on the outer circumference of the holding tube 15 such that the resilient ring 20b bears against the dial support 17. The resilient ring can, for example, be of the circlip type in order to ease disassembly of the attachment device. Similarly to the first embodiment, the holding tube 15 is housed inside the tubular portion formed by the stack of the different supports 17, 26, 28 in order to produce this rigid base suitable for a dial 12 comprising or formed by a solar cell. One end of the holding tube 15 comprises the radial extension 18, that is, for example, annular in shape, and that is attached to a bridge 10a of the drive module 10.

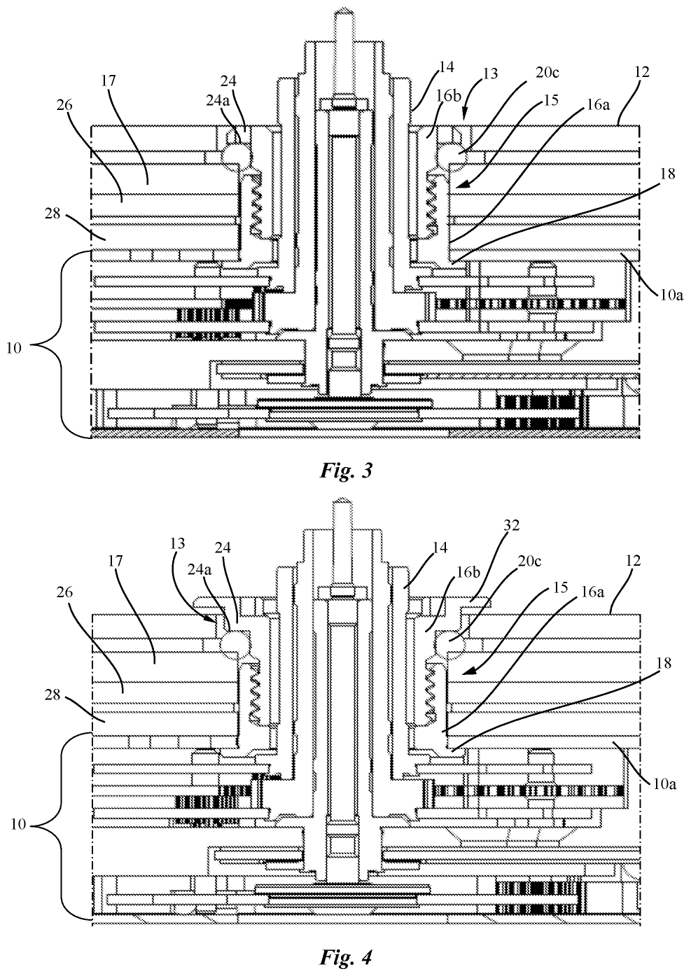

According to FIG. 3, which shows a third embodiment of the invention, the holding tube 15 comprises a first tube 16a comprising, on the one hand, a radial extension attached to a bridge 10a of the drive module 10, and on the other hand, a threaded part on the inner circumference thereof. The first tube 16a is housed inside the tubular portion formed by the stack of the different supports 17, 26, 28 producing this rigid base. The holding tube 15 further comprises a second tube 16b in the form of a screw screwed into the threaded part of the first tube 16a. The screw 16b comprises, at one end, a radial extension 24 in order to form a circular bearing surface 24a. In the attachment device, the retaining member 20c comprises a gasket 20c, for example of the O-ring type. This gasket 20c is arranged against the circular bearing surface 24a of the screw 16b and the dial support 17 so as to exert an axial force on the dial support 17. The screw 16b is embedded in the central opening 13 of the dial 12. In order to attach a conventional dial, the diameter of the radial extension 24 is preferably substantially identical to the diameter of the central opening 13 of the dial in order to procure an advantageous aesthetic appearance.

Alternatively, the retaining member 20c of the attachment device comprises a gasket 20c which is arranged against the circular bearing surface 24a of the screw 16b and the dial support 17. Under these conditions, the radial extension 24 forming a circular bearing surface 24a defined at the end of said screw 16b is thus capable of directly exerting an axial force on the dial support 17 by way of the retaining member 20c.

According to FIG. 4, which shows a fourth embodiment of the invention, the device for attaching the dial comprises a holding tube of a similar design to that of the third embodiment, with the exception that the screw 16b comprises a part 32 that is raised relative to the dial 12 which extends radially in order to cover the central opening 13 of the dial 12. This embodiment is particularly suited for a dial comprising or formed by a solar cell, since the raised part 32 has the advantage of concealing the solar cell's cutting defects.

The retaining washer 20a according to FIG. 1, the circlip 20b according to FIG. 2, and the second tube 16b in the form of a screw screwed into the threaded part of the first tube 16a according to FIGS. 3 and 4 all have the advantage of preventing the hands from being driven out during a significant axial impact.

It goes without saying that the invention is not limited to the embodiments described with reference to the figures and alternatives could be implemented without leaving the scope of the invention. For example, the holding tube 15 according to any of the embodiments described hereinabove can be adapted so as to bear against or exert an axial stress directly on the dial 12 itself and not on the dial support 17, or indeed directly on both the dial support 17 and the dial 12. For this purpose, the dial 12 can, for example, comprise a dial part that is adjacent to the central opening 13 of the dial against which bears the retaining member, such as the retaining washer 20a, the circlip 20b or the gasket 20c depending on the embodiment chosen from among those described hereinabove. The part of the dial that is adjacent to the central opening 13 can define an annular area that is set back relative to the largest part of the surface of the dial, such that a surface of the top part of the holding tube is level with the dial.

The attachment device according to the invention has the advantage of allowing dials to be produced using different materials which are not compatible with the manufacture of dials having feet. These dials can in particular be obtained using plastic, metal or glass injection methods.

1-11. (canceled)

12. A timepiece comprising:
a drive module; and
a dial comprising a central opening, an hour pipe passing through the central opening of the dial and driven in rotation by the drive module, and an attachment device to attach the dial,
wherein said attachment device comprises:
a holding tube arranged around the hour pipe and mechanically connected to the drive module, and
a retaining member arranged between the holding tube and the dial and/or a dial support to which the dial is attached.

13. The timepiece according to claim 12, wherein the retaining member is arranged between the holding tube and the dial and/or a dial support while bearing against a part of the dial that is adjacent to the central opening of the dial and/or against the dial support.

14. The timepiece according to claim 12, wherein a part of the dial adjacent to the central opening of the dial defines an annular bearing area that is set back relative to the surface of the dial, such that a surface of the top part of the holding tube is level with the surface of the dial.

15. The timepiece according to claim 12, wherein a holding tube comprises a first cylindrical part having a first diameter and a second cylindrical part having a second diameter that is less than the first diameter, and the retaining member is a washer arranged on the circumference of the second cylindrical part and bearing against the annular area of the dial or against the dial support so as to exert an axial force on the dial or the dial support.

16. The timepiece according to claim 12, wherein the retaining member is a resilient ring arranged inside a groove made on at least one part of the outer circumference of the holding tube such that the resilient ring bears against the annular area of the dial or against the dial support.

17. The timepiece according to claim 16, wherein the resilient ring is a circlip.

18. The timepiece according to claim 12, wherein the holding tube comprises a first tube mechanically connected to the drive module and comprising a threaded part on the inner circumference thereof, and a second tube in the form of a screw screwed into the threaded part of the first tube, the screw comprising a radial extension to form a circular bearing surface and the retaining member is in the form of a gasket arranged against the circular bearing surface of the screw and the annular area of the dial or the dial support so as to exert an axial force on the dial or the dial support.

19. The timepiece according to claim 18, wherein the gasket is an O-ring.

20. The timepiece according to claim 18, wherein the screw is embedded in the central opening of the dial.

21. The timepiece according to claim 18, wherein the screw comprises a part which is raised relative to the dial and which extends radially to cover the central opening of the dial.

22. The timepiece according to claim 12, further comprising:
a movement support and a circuit support, arranged between the dial support and the drive module, a stack of the dial support, the movement support, and the circuit support forming a rigid base preventing the dial from becoming deformed in the event of an axial impact.

23. The timepiece according to claim 12, wherein the dial support, the movement support, and the circuit support each comprise a central opening to form a recess inside which the holding tube is at least partially adjusted.

24. The timepiece according to claim 12, wherein the dial comprises or is formed by at least one solar cell.
